(19) United States
(12) Patent Application Publication
(10) Pub. No.: US 2008/0189958 A1
(43) Pub. Date: Aug. 14, 2008

(54) Shield for a string trimmer

(76) Inventor: Edward P. Hurley, Sara Sota, FL (US)

Correspondence Address: Edward P. Hurley, 1214 Western Pine Circle, Sara Sota, FL, 34240, US

(21) Appl. No.: 12/082,529

(22) Filed: Apr. 11, 2008

Related U.S. Application Data
(63) Continuation-in-part of application No. 11/008,037, filed on Dec. 9, 2004, now abandoned.

(51) Int. Cl. A01D 34/62

(52) U.S. Cl. 30/286; 56/12.7

(57) ABSTRACT

A shield with a cutting disk having minimum weight with respect to a boom holding angle, the cutting disk dampened at a shield protective by a wind tunnel, the wind tunnel forming a high-pressure cylinder having a reciprocal fluid flow inlet and outlet with a small trough capable of removing a significant amount of debris, the wind tunnel allowing a portion of the cutting disk to pass through the cylinder to stabilize the cutting disk transverse flow, the wind tunnel having one or more oval or straight blades separating a portion of the cutting disk from the shield to stabilize the cutting disk tangential flow and can be placed downwind of prevailing breezes and the cutting disk stabilized by turf grass.

### CROSS REFERENCE TO RELATED APPLICATIONS

This is a continuation in part of Ser. No. 11/008,037, filed on Dec. 9, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of grounds maintenance and more specifically to a shield for a string trimmer.

The hand-held string trimmer market has evolved into almost a billion-dollar industry from an initial concept that a cord could be fastened to an empty tin container so as to cut vegetation with stiff centrifugal force without posing significant risk of metallic lacerations to an operator. The US outdoor power equipment industry sells about three-million six-hundred thousand string trimmers to households and about one-million eight-hundred thousand of them to professional end users. Some retail safety standards could be jeopardized when a majority of these home lawn tools are mistakenly sold as commercial units. Furthermore, too much leeway in the retail sector can confuse or relax broad safety standards which can unfairly drive up the cost of yard tools. In fact, a ninety-nine dollar and ninety-nine cent retail brush cutter with high vibration may be the only present alternative of maintaining a continuous US grounds operation after a smooth running five-hundred dollar commercial string trimmer goes down for repairs. One may observe that a significant number of US retail string trimmers could be sold on the cheap to commercial landscapers when competing for landscaping bids is based on a shoe string budget. Economically speaking, about three-hundred and fifty-thousand US citizens could be exposed to significant amounts of lawn tool vibration if a reasonable ten percent of retail string trimmers are mistakenly sold as commercial units.

String trimmers typically are provided with an operator manual that will sometimes describe ways of controlling long periods of high frequency vibration. The string trimmer owners manual further encourages the use of a safety shield with debris dispersion protection for an operator. String trimmer shields are mounted between the operator and a fixed or an automatic feed string line filament cutting head to supply protection to an operator and to provide more uniform cutting tip power. An unbalanced cutting guard can restrict ergonomic comfort to bring about operator fatigue faster whereas the removal of the guard can raise serious protection and vibration concerns. Moreover, the elongated flexible string line filament can bend drastically due to high resistance. Therefore, a shield having a symmetrical design along with improved vibration dampening qualities for both the retail and commercial outdoor power equipment industry may lower overall cost of string trimmers and reduce health risks.

Ironically, grounds maintenance shields are often removed from string trimmers because the guard can be somewhat bulky, the strengthening supports can cause string line filament to pulsate and collect unwanted debris to weigh down the operation, one or more of the walls could expose debris to an operator from a strong head wind or the asymmetrical shape won't reasonably adapt to several right and left handed ergonomic trimming and edging combinations. U.S. Pat. No. 4,550,499 describes a narrow shield having a thick side pocket and bottom reinforcements that could cause string line to pulsate to further discourage its use. In addition, some shields are removed because the extra weight is difficult to balance in an operative position which can lead to more vibration. A pair of safety glasses could be seen as a lighter shield alternative during string trimming operation, but safety glasses sometimes get misplaced or could be mostly ignored during short term retail use which is why protective shields need to have their own set of enhancement rules and standards for retail consumers to live by.

Well constructed commercial string trimmers can vibrate just as much as their rough going retail counterparts. For instance, an asymmetrical vortex shedding of airflow around flexible string line filament, heavy-tool resistance translated into lightweight materials, air drag along cutting guard side walls, power transfer oscillation, poor string line filament tip orientation and awkward ergonomic holding positions are just a few of the known risks associated with string trimmer vibration. Hand-arm and whole-body ailments are better to treat than having to perform emergency surgery for lacerations because of accidents related to exposed cutters. Nevertheless, string trimmers will vibrate under high resistance. In fact, there tends to be longer string line when a shield is removed from a string trimmer which takes longer for vibration to dampen. Outdoor commercial equipment like string trimmers and hand-held metallic yard tool devices serve an important purpose which is why they should both be exercised during reasonable operating cycles, not abused in the same working position. As a basic rule of thumb, string trimmer control positions should be comfortable and adjusted regularly to exercise and rest different muscle group. Most importantly, the string line filament of commercial and retail cutting disks should maintain a reasonably stable position to avoid excessive amounts of vibration translating into an operator.

This patent application attempts to correct some of the stabilizing drawbacks of string trimmers by encouraging the use of a vibration dampening shield. Stabilizing string line filament will not only grow today's one-billion dollar plus US hand-held yard tool market, but our health costs should be lowered as a result of adding accurate and affordable safety features.

### BRIEF SUMMARY OF THE INVENTION

The primary object of the invention is to provide a shield for a string trimmer operation.

Another object of the invention is to provide the shield with a debris deflector for right and left handed ergonomic use.

Another object of the invention is to provide the shield with a windshield for right and left handed ergonomic use.

A further object of the invention is to provide the shield with a wind tunnel.

A further object of the invention is to provide the shield with a wind tunnel.

Yet another object of the invention is to provide the wind tunnel with minimal weight for right and left handed ergonomic use.

Still yet another object of the invention is to provide the wind tunnel with one or more vibration dampeners for the string trimming operation.

Another object of the invention is to provide the wind tunnel with one or more vibration dampening cutting blades.

Another object of the invention is to provide the wind tunnel with aerodynamic qualities.

A further object of the invention is to provide the wind tunnel with aerodynamic debris dispersion qualities.

Yet another object of the invention is to provide a reasonably soft transport platform at all times for the string trimmer operation.

Still yet another object of the invention is to provide more vibration dampening options for the string trimmer operation.

Another object of the invention is to provide the shield with energy saving for a power source heat stack.

Another object of the invention is to provide the string trimmer operation with a faster tool.

A further object of the invention is to provide the string trimmer operation with less translated energy to an operator.

Yet another object of the invention is to provide upper and lower lawn edging guides for safe maneuvering around sensitive vegetation.

Still yet another object of the invention is to provide the wind tunnel with a small open trough for air and debris to pass through.

Another object of the invention is to provide means for the open trough to hold a tiny amount of debris to help stabilize the string trimmer operation and insulate noise.

Another object of the invention is to provide the open trough with congruent inclines for easy clean up.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a shield for a string trimmer comprising: a yard tool, a power source, a cutting disk, a boom, the power source connected at a translating end of the boom, the cutting disk connected at a rotating end of the boom, the cutting disk having one or more string line filaments operatively connected in a straight, looped or coiled position, a shield, the shield having minimum weight with respect to the shaft holding angle, the shield having a bracket end, the shield having a protective end, the cutting disk dampened at the shield protective end, the shield mounted to the yard tool at the bracket end, the shield protective end having a debris deflector for right and left handed trimming operation, the shield protective end having a wind absorber for right and left handed lawn edging operation, the shield protective end having a upper and lower lawn edging guides, the shield protective end generally consisting of a wind tunnel, the wind tunnel forming a high-pressure cylinder or hourglass, the wind tunnel having one or more dimples, the wind tunnel having a string trimmer skid, the wind tunnel having a reciprocal fluid flow inlet end and an outlet end, the wind tunnel having a small trough, the trough having means to contain an insignificant amount of debris, the debris capable of stabilizing the cutting disk, the cutting disk capable of removing a significant amount of debris from the wind tunnel, the wind tunnel having a damper, the damper allowing a portion of the cutting disk to pass through the wind tunnel cylinder, the wind tunnel having means to stabilize the cutting disk transverse flow, the wind tunnel having one or more blades, the blades can be oval or straight, the blades having means of separating a portion of the cutting disk from the shield inlet or exhaust ends, the blades having means to stabilize the cutting disk tangential flow, the wind tunnel having means to be placed downwind of prevailing breezes at all times of lawn edging, the cutting disk having means to be substantially stabilized by turf grass at all times of lawn edging.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a yard tool illustrating a string trimmer with a shield attached.

FIG. 2 is a top perspective view of FIG. 1 illustrating the shield with a protective end opposite of where a bracket end of the shield converges.

FIG. 3 is a lower perspective view of FIG. 1 illustrating the shield with blades used to help stabilize a wind tunnel and an operable cutting disk (not shown.)

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

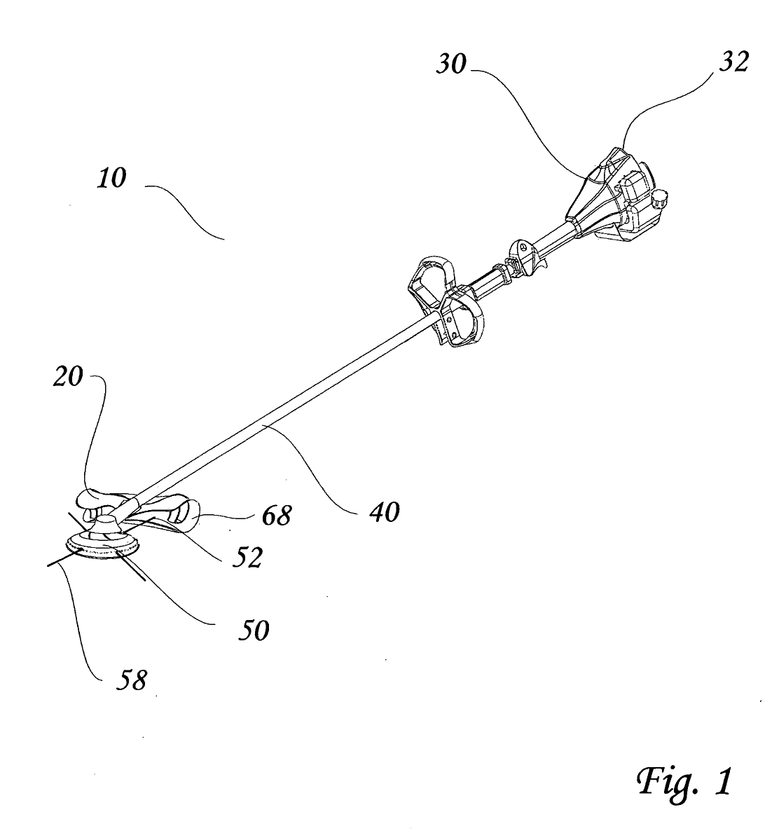

Referring to FIG. 1, the yard tool 10 specifically describes a string trimmer comprising a cutting disk 50 mounted at a boom 40 rotating end and a power source 30 mounted to the boom 40 at a translating end. The cutting disc 50 trims and disperses yard material in all sorts of directions. A shield 20 helps to separate the cutting disk 50 from an operator (not shown) which will be discussed in more detail below.

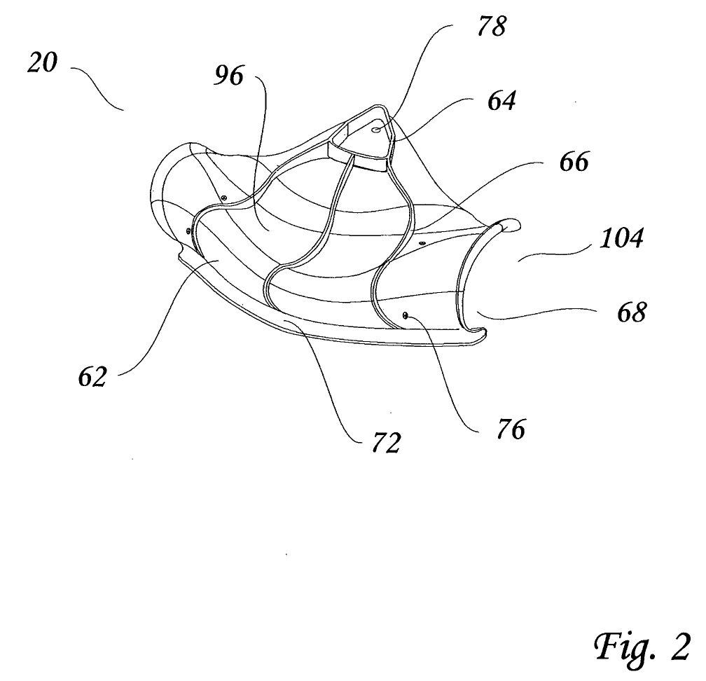

Now referring to FIG. 1 and FIG. 2, the boom 40 and cutting disk 50 can be quickly interchanged with a plurality of tool devices known to the art. One or more string line filaments 58 are operatively connected within an interior section of the cutting disk 50 in a straight, looped or coiled position (not shown) with one or more cutting tips 52 at the cutting disk 50 exterior end. The power source 30 drives the cutting disk 50 within one orthogonal isometry, that is, the boom 40 shortest path of transformation for precise grounds trimming and lawn edging. It is preferred that the operable cutting disc 50 have one or more dimples 54 to cool the cutting tips 52 and three or more small central apex air vanes 56 to cool off the inner cutting disk 50 and the boom 40 during yard tool 10 strain, but the cutting disk 50 can also be smooth and rounded like a straight cylinder (not shown.) The shield 20 can be mounted to a plurality of booms (only one shown) known in the art according to sound engineering judgment. The power source 32 further provides a stack 32 to allow heat to naturally escape when the operable cutting disk 50 tip develops high resistance strain.

Still referring to FIG. 1-FIG. 2, one or more apertures 78 permit the shield 20 to mount to the boom 40 at a bracket 64 end. The bracket 64 can be made of different shapes and materials according to sound engineering judgment. A portion of the cutting disk 50 operable string line filament 58 tips 52 are suspended within a wind tunnel 68 at the shield 20 protective 62 end. The wind tunnel 68 is shaped into a high-pressure cylinder hourglass, but the shape can vary by satisfying proven engineering principles. The shield 20 protective 62 end width is determined by the yard tool 10 holding and rotation angles. Therefore, the shield 20 weight and material are minimized with respect to having a reasonable short distance for the cutting disk 50 to maneuver right or left with the boom 40. The shield 20 protective 62 end having a wind absorber 94 for controlling right and left handed lawn edging operation

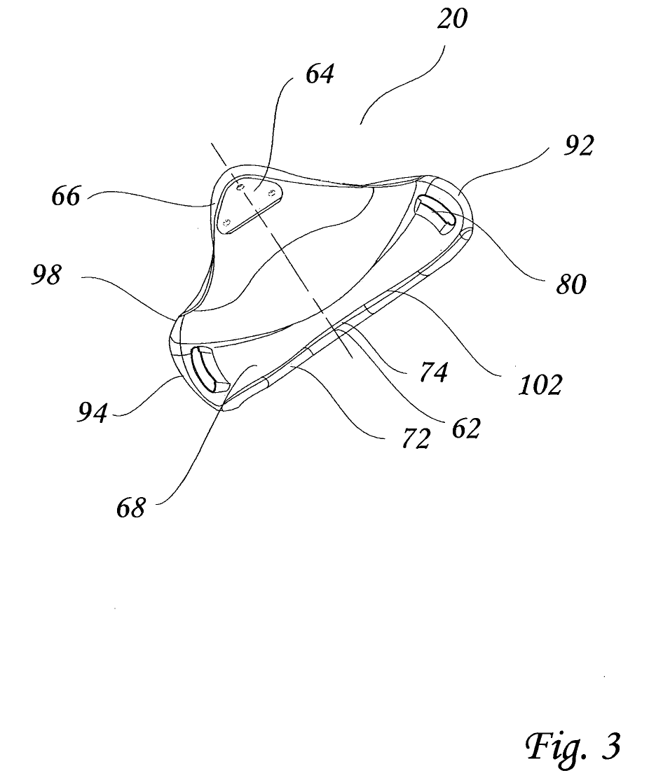

Referring to FIG. 1 and FIG. 3, the wind tunnel 68 has a dampener 74 for whenever the string line filament 58 reaches a limit for disobeying Hooke's Law of Elasticity. There is a slight drag when the string line filament glides across the dampener 74 which controls the yard tool 10 operation at a predetermined speed for safe keeping. The wind tunnel 68 has one or more dimples. One or more blades 80 act to support the shield 20 and keep the wind tunnel 68 and cutting disk 50 balancing during the cutting disk 50 rotation. The blades 80 are concave in shape to cut the orthogonal string line filament 58 with the least amount of width and force during the yard tool 10 operation, but the blades 80 can be made straight, oval or other curved geometric shapes to enhance the wind tunnel 68 performance. The shield 20 protective 62 end having a debris deflector for right and left handed grounds trimming and lawn edging operation. The shield 20 protective 62 end having upper and lower lawn edging guides. The shield 20 protective end 62 provides a skid 72 to stabilize the yard tool 10 and to keep the wind tunnel 68 reasonably clean. The wind tunnel 68 has a small trough 102 that is self-cleaning in a vertical edging position (not shown.) In addition, the cutting disk 20 is capable of removing a reasonable amount of debris with sweeping action of the cutting disk 50 tips 52 within the wind tunnel 68. Moreover, a small amount of settled debris in the trough 102 further helps to stabilize the string line filament 58 and cutting disk 50. The wind tunnel 68 has reciprocal fluid flow inlet 92 and outlet 94 ends.

Referring back to FIG. 1, FIG. 2 and FIG. 3, the wind tunnel 20 having a low-pressure damper 104 allowing a portion of the cutting disk 50 to pass through the wind tunnel 68 cylinder. Therefore, the wind tunnel 68 will stabilize the cutting disk 50 transverse flow under reasonable working conditions. The blades having means of separating a portion of the cutting disk 50 from the shield 20 inlet 92 or outlet 94 ends to stabilize the string line filament 58 and cutting disk 50 tangential flow. The wind tunnel 68 can be placed downwind of prevailing breezes at all times of lawn edging. The string line filament 58 and cutting disk 52 is capable of being substantially stabilized by turf grass and other soft vegetation.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A shield for a string trimmer comprising:
a yard tool;
a power source;
a cutting disk;
a boom;
the power source connected at a translating end of the boom;
the cutting disk connected at a rotating end of the boom;
the cutting disk having one or more string line filaments operatively connected in a straight, looped or coiled position;
a shield;
the shield having minimum weight with respect to the shaft holding angle;
the shield having a bracket end;
the shield having a protective end;
the cutting disk dampened at the shield protective end;
the shield mounted to the yard tool at the bracket end;
the shield protective end having a debris deflector for right and left handed trimming operation;
the shield protective end having a wind absorber for right and left handed lawn edging operation;
the shield protective end having an upper and a lower lawn edging guide;
the shield protective end generally consisting of a wind tunnel;
the wind tunnel forming a high-pressure cylinder or hourglass;
the wind tunnel having one or more dimples;
the wind tunnel having a string trimmer skid;
the wind tunnel having a reciprocal fluid flow inlet end and an outlet end;
the wind tunnel having a small trough;
the trough having means to contain an insignificant amount of debris;
the debris capable of stabilizing the cutting disk;
the cutting disk capable of removing a significant amount of debris from the wind tunnel;
the wind tunnel having a damper;
the damper allowing a portion of the cutting disk to pass through the wind tunnel cylinder;
the wind tunnel having means to stabilize the cutting disk transverse flow;
the wind tunnel having one or more blades;
the blades preferably convex, but they can be oval or straight;
the blades having means of separating a portion of the cutting disk from the shield inlet or outlet ends;
the wind tunnel and blades having means to stabilize the cutting disk tangential flow;
the wind tunnel having means to be placed downwind of prevailing breezes at all times of lawn edging;
the cutting disk having means to be substantially stabilized by turf grass at all times of lawn edging.
